(19) United States
(12) Patent Application Publication
(10) Pub. No.: US 2025/0125112 A1
(43) Pub. Date: Apr. 17, 2025

(54) FUSE HOLDER WITH SLIDING JOINT

(71) Applicant: Littelfuse, Inc., Chicago, IL (US)

(72) Inventors: Sergio Armendariz Molina, Chicago, IL (US); Jesus Roberto Morales, Chicago, IL (US)

(73) Assignee: Littelfuse, Inc., Chicago, IL (US)

(21) Appl. No.: 18/487,194

(22) Filed: Oct. 16, 2023

(51) Int. Cl. H01H 85/20

(52) U.S. Cl. CPC H01H 85/20; H01H 2085/209

(57) ABSTRACT

A fuse holder can include a first holding part and a second holding part. The first holding part can include a first mounting apparatus, a first joint interface, and a first conductive terminal therebetween, and the second holding part can include a second mounting apparatus, a second joint interface, and a second conductive terminal therebetween. The first joint interface can lock with the second joint interface in a primary latching position or a secondary latching position. When the first joint interface locks with the second joint interface in the primary latching position, the first conductive terminal can be a first distance from the second conductive terminal, but when the first joint interface locks with the second joint interface in the secondary latching position, the first conductive terminal can be a second distance from the second conductive terminal that is greater than the first distance.

### FIELD

The present disclosure generally relates to fuse holders. More particularly, the present disclosure relates to a fuse holder with a sliding joint.

### BACKGROUND

A fuse is commonly used as a circuit protection device and can provide electrical connections between sources of electrical power and circuit components to be protected, for example, in automotive and power distribution environments. A fuse holder is a device to hold a fuse in place and can include conductive terminals at ends thereof to connect the fuse between the electrical power and the circuit components to be protected.

Fuses can be different sizes and have different lengths or pitches. As such, fuse holders known in the art are also different sizes. Indeed, known fuse holders are designed and built to hold fuses of a single size and cannot accommodate fuses of different sizes. For example, FIG. 1A is a perspective view of a fuse holder 102 known in the art holding a fuse 108, and FIG. 1B is a perspective view of a fuse holder 110 known in the art holding a fuse 116. As seen in FIG. 1A, conductive terminals 104, 106 of the fuse holder 102 can be connected to ends of the fuse 108 and have a single, fixed distance therebetween that accommodates a length and a pitch of the fuse 108. Similarly, as seen in FIG. 1B, conductive terminals 112, 114 of the fuse holder 110 can be connected to ends of the fuse 116 and have a single, fixed distance therebetween that accommodates a length and a pitch of the fuse 116. As such, when the fuse 108 and the fuse 116 have different lengths and pitches, the fuse holder 102 cannot accommodate and hold the fuse 116, and the fuse holder 110 cannot accommodate and hold the fuse 108.

In view of the above, there is a continuing, ongoing need for improved fuse holders.

### BRIEF SUMMARY

This Brief Summary is provided to introduce a selection of concepts in a simplified form that are further described below in the Detailed Description. This Brief Summary is not intended to identify key features or essential features of claimed subject matter or intended as an aid in determining scope of the claimed subject matter.

In some embodiments, a fuse holder can include a first holding part and a second holding part. The first holding part can include a first mounting apparatus at a first end of the first holding part, a first joint interface at a second end of the first holding part opposite the first end of the first holding part, and a first conductive terminal in between the first end of the first holding part and the second end of the first holding part. The second holding part can include a second mounting apparatus at a first end of the second holding part, a second joint interface at a second end of the second holding part opposite the first end of the second holding part, and a second conductive terminal in between the first end of the second holding part and the second end of the second holding part. The first joint interface can lock with the second joint interface in a primary latching position or a secondary latching position. When the first joint interface locks with the second joint interface in the primary latching position, the first conductive terminal can be a first distance from the second conductive terminal, but when the first joint interface locks with the second joint interface in the secondary latching position, the first conductive terminal can be a second distance from the second conductive terminal. The second distance can be greater than the first distance.

In some embodiments, the second holding part can slide relative to the first holding part to move the second joint interface between the primary latching position and the secondary latching position.

In some embodiments, the second joint interface can be unlocked from the first joint interface to move the second joint interface between the primary latching position and the secondary latching position.

In some embodiments, the first joint interface can lock with the second joint interface to create a joint device.

In some embodiments, the joint device can be I-shaped.

In some embodiments, the joint device can slide along an X axis between the primary latching position and the secondary latching position.

In some embodiments, the first conductive terminal and the second conductive terminal can accommodate a first fuse device with a first length when the first joint interface locks with the second joint interface in the primary latching position, and the first conductive terminal and the second conductive terminal can accommodate a second fuse device with a second length when the first joint interface locks with the second joint interface in the secondary latching position. The second length can be longer than the first length.

In some embodiments, a fuse holder can include a first holding part and a second holding part. The first holding part can include a first joint interface and a first conductive terminal, and the second holding part can include a second joint interface and a second conductive terminal. The first joint interface can lock with the second joint interface in a primary latching position or a secondary latching position. When the first joint interface locks with the second joint interface in the primary latching position, the first conductive terminal can be a first distance from the second conductive terminal, but when the first joint interface locks with the second joint interface in the secondary latching position, the first conductive terminal can be a second distance from the second conductive terminal. The second distance can be greater than the first distance.

In some embodiments, the second holding part can slide relative to the first holding part to move the second joint interface between the primary latching position and the secondary latching position.

In some embodiments, the second joint interface can be unlocked from the first joint interface to move the second joint interface between the primary latching position and the secondary latching position.

In some embodiments, the first joint interface can lock with the second joint interface to create a joint device.

In some embodiments, the joint device can be I-shaped.

In some embodiments, the joint device can slide along an X axis between the primary latching position and the secondary latching position.

In some embodiments, the first conductive terminal and the second conductive terminal can accommodate a first fuse device with a first length when the first joint interface locks with the second joint interface in the primary latching position, and the first conductive terminal and the second conductive terminal can accommodate a second fuse device with a second length when the first joint interface locks with the second joint interface in the secondary latching position. The second length can be longer than the first length.

In some embodiments, a method can include locking a first holding part of a fuse holder and a second holding part of the fuse holder in a primary latching position to create a first distance between a first conductive terminal of the first holding part and a second conductive terminal of the second holding part, unlocking the first holding part from the second holding part, and locking the first holding part and the second holding part in a secondary latching position to create a second distance between the first conductive terminal and the second conductive terminal, the second distance being greater than the first distance.

In some embodiments, after unlocking the second holding part from the first holding part, the method can include sliding the second holding part relative to the first holding part to move between the first latching position and the secondary latching position.

In some embodiments, the method can include mounting a first fuse device with a first length to the first conductive terminal and the second conductive terminal when the first holding part and the second holding part are locked in the primary latching position and mounting a second fuse device with a second length to the first conductive terminal and the second conductive terminal when the first holding part and the second holding part are locked in the secondary latching position. The second length can be longer then the first length.

In some embodiments, the method can include locking a first joint interface of the first holding part with a second joint interface of the second holding part to create a joint device in the primary latching position or the secondary latching position.

In some embodiments, the joint device can be I-shaped.

In some embodiments, the method can include sliding the joint device along an X axis of the fuse holder between the primary latching position and the secondary latching position.

Other technical features may be readily apparent to one skilled in the art from the following figures, descriptions, and claims.

### BRIEF DESCRIPTION OF THE SEVERAL VIEWS OF THE DRAWINGS

FIG. 1A is a perspective view illustrating a fuse holder and a fuse device known in the art.

FIG. 1B is a perspective view illustrating a fuse holder and a fuse device known in the art.

FIG. 2A is a perspective view illustrating a fuse holder and a fuse device in accordance with disclosed embodiments.

FIG. 2B is a top view illustrating a fuse holder in accordance with disclosed embodiments.

FIG. 2C is a perspective view illustrating a fuse holder and a fuse device in accordance with disclosed embodiments.

FIG. 2D is a top view illustrating a fuse holder in accordance with disclosed embodiments.

FIG. 3A is a perspective view illustrating a fuse holder and a fuse device in accordance with disclosed embodiments.

FIG. 3B is a top view illustrating a fuse holder in accordance with disclosed embodiments.

FIG. 3C is a perspective view illustrating a fuse holder and a fuse device in accordance with disclosed embodiments.

FIG. 3D is a top view illustrating a fuse holder in accordance with disclosed embodiments.

FIG. 4A is a top view illustrating a joint device in accordance with disclosed embodiments.

FIG. 4B is a cross-sectional view illustrating the joint device of FIG. 4A along line H-H in accordance with disclosed embodiments.

FIG. 4C is a cross-sectional view illustrating the joint device of FIG. 4A along line B-B in accordance with disclosed embodiments.

FIG. 4D is a cross-sectional view illustrating the joint device of FIG. 4A along line C-C in accordance with disclosed embodiments.

FIG. 5A is a top view illustrating a joint device in accordance with disclosed embodiments.

FIG. 5B is a cross-sectional view illustrating the joint device of FIG. 5A along line J-J in accordance with disclosed embodiments.

FIG. 6A is a top view illustrating a joint device in accordance with disclosed embodiments.

FIG. 6B is a cross-sectional view of the joint device of FIG. 6A along line K-K in accordance with disclosed embodiments.

FIG. 6C is a cross-sectional view of the joint device of FIG. 6A along line F-F in accordance with disclosed embodiments.

FIG. 6D is a cross-sectional view of the joint device of FIG. 6A along line E-E in accordance with disclosed embodiments.

FIG. 7 is a flow chart illustrating a method in accordance with disclosed embodiments.

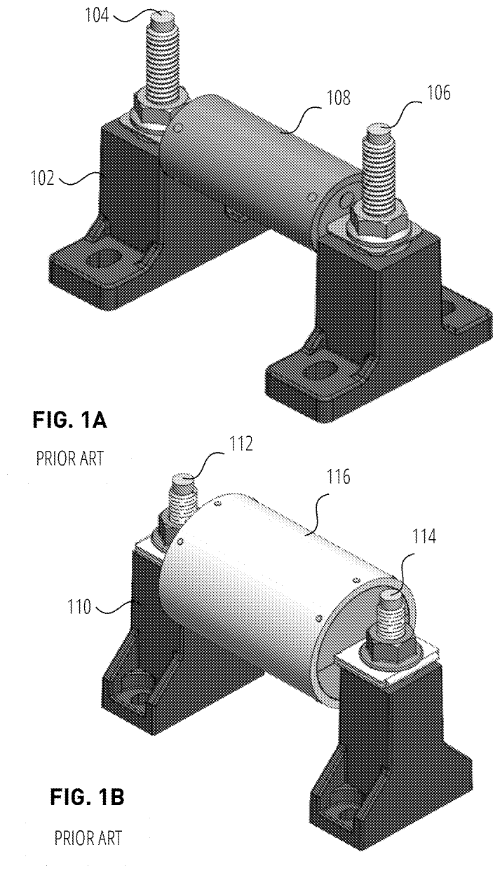

### DETAILED DESCRIPTION

Exemplary embodiments of a fuse holder with a sliding joint in accordance with the present disclosure will now be described more fully hereinafter with reference made to the accompany drawings. The fuse holder with the sliding joint may, however, be embodied in many different forms and should not be construed as being limited to the embodiments set forth herein. Rather, these embodiments are provided so that this disclosure will convey certain exemplary aspects of a fuse holder with a sliding to those skilled in the art.

As disclosed herein, a fuse holder can be used to hold, accommodate, and support fuse devices of different sizes. For example, the fuse holder can include a sliding joint that can be latched in different positions to adjust a length of the fuse holder, thereby allowing the fuse holder to fit fuse devices with different lengths and pitches. Advantageously, despite being adjustable, the sliding joint can simultaneously provide stability and stiffness to the fuse holder as needed.

In some embodiments, the fuse holder as disclosed herein can hold, support, and accommodate fuse devices of any two sizes as would be known and desired by one of skilled in the art, including large body, high voltage fuse devices. For example, in one specific embodiment, in a first configuration, the fuse holder can fit a 500V fuse device with a current range of 60-600 A, an overall length of 73 mm or 93 mm, and a centerline pitch of 60 mm or 75 mm and, in a second configuration, the fuse holder can fit a 1000V fuse device with a current range of 60-600 A, an overall length of 110.5 mm, 110.7 mm, or 122 mm, and a centerline pitch of 91.25 mm or 100 mm. However, it is to be understood that these specifications are exemplary only and that, in the first configuration, the fuse holder can be designed to fit any first fuse device with first specifications and, in the second configuration, the fuse holder can be designed to fit any second fuse device with second specifications. It is also to be understood that, in some embodiments, the fuse holder can hold, support, and accommodate fuse devices of a plurality of different sizes, such as three different sizes, four different sizes, and more by moving to a plurality of different configurations that is more than two.

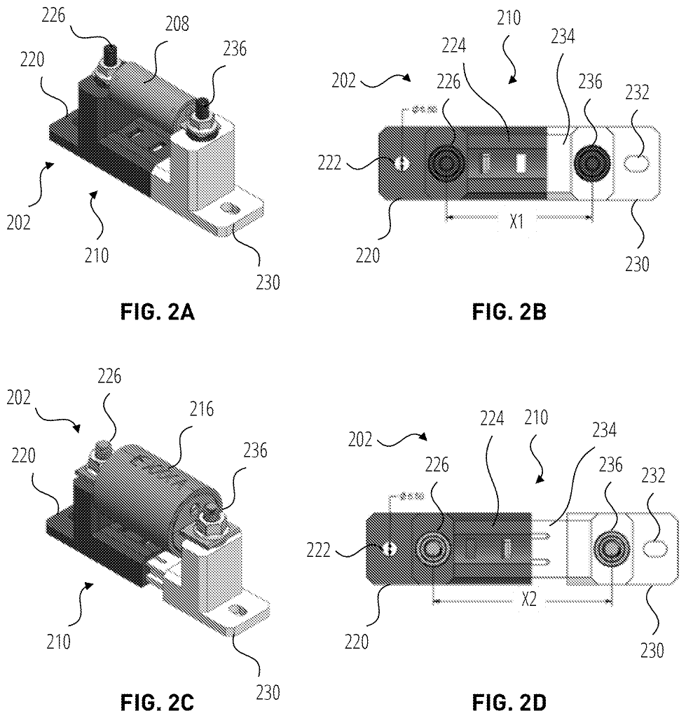

FIG. 2A is a perspective view illustrating a fuse holder 202 and a fuse device 208 in a first configuration, for example, a primary latching position, in accordance with disclosed embodiments, and FIG. 2B is a top view of the fuse holder 202 in the first configuration, that is, the primary latching position. FIG. 2C is a perspective view illustrating the fuse holder 202 and the fuse device 208 in a second configuration, for example, a secondary latching position, in accordance with disclosed embodiments, and FIG. 2D is a top view of the fuse holder 202 in the second configuration, that is, the secondary latching position.

As seen, the fuse holder 202 can include a first holding part 220 and a second holding part 230. The first holding part 220 can include a first mounting apparatus 222 at a first end of the first holding part 220, a first joint interface 224 at a second end of the first holding part 220 opposite the first end of the first holding part 220, and a first conductive terminal 226 in between the first end of the first holding part 220 and the second end of the first holding part 220. Similarly, the second holding part 230 can include a second mounting apparatus 232 at a first end of the second holding part 230, a second joint interface 234 at a second end of the second holding part 230 opposite the first end of the second holding part 230, and a second conductive terminal 236 in between the first end of the second holding part 230 and the second end of the second holding part 230.

The first joint interface 224 can lock with the second joint interface 234 in the primary latching position as illustrated in FIG. 2A and FIG. 2B or in the secondary latching position as illustrated in FIG. 2C and FIG. 2D to create and form a joint device 210. That is, the joint device 210 can be formed by the first joint interface 224 and the second joint interface 234 when latched together. When the joint device 210 is formed in the primary latching position, that is, the first joint interface 224 locks with the second joint interface 234 in the primary latching position, the first conductive terminal 226 can be a first distance X1 from the second conductive terminal 236. However, when the joint device 210 is formed in the secondary latching position, that is, the first joint interface 224 locks with the second joint interface 234 in the secondary latching position, the first conductive terminal 226 can be a second distance X2 from the second conductive terminal 236. As seen in FIG. 2B and FIG. 2C, the second distance X2 can be greater than the first distance X1.

To move between the primary latching position and the secondary latching position, the joint device 210 can slide along an X axis between the primary latching position and the secondary latching position. For example, the second holding part 230 can slide relative to the first holding part 220, including toward or away from and/or into or out of, to move between the primary latching position and the secondary latching position. In some embodiments, the second joint interface 234 can be unlocked from the first joint interface 224 to move the second joint interface 234 between the primary latching position and the secondary latching position.

The same one single fuse holder 202 is illustrated in FIGS. 2A-2D, albeit in different configurations. As such, the fuse holder 202 can hold a first fuse device 208 with a first length and pitch in the first configuration, that is, the primary latching position, but can also hold a second fuse device 216 with a second length and pitch in the second configuration, that is, the secondary latching position. The second length and pitch can be longer than the first length and pitch, but a different fuse holder is not required. In particular, the first conductive terminal 226 and the second conductive terminal 236 can accommodate the first fuse device 208, for example, by connecting thereto, when the first joint interface 224 locks with the second joint interface 234 in the primary latching position. However, the first conductive terminal 226 and the second conductive terminal 236 can accommodate the second fuse device 216, for example, by connecting thereto, when the first joint interface 224 locks with the second joint interface 234 in the secondary latching position.

Once configured in the primary latching position or the secondary latching position, the fuse holder 202 can be mounted to any desired device as would be known and desired by one of skilled in the art. For example, in some embodiments, the first mounting apparatus 222 and the second mounting apparatus 232 can be secured to a panel or other device via mounting hardware. In some embodiments, the first mounting apparatus 222 and/or the second mounting apparatus 232 can include an M6 hole or slot for receiving an M6 stud and/or nut.

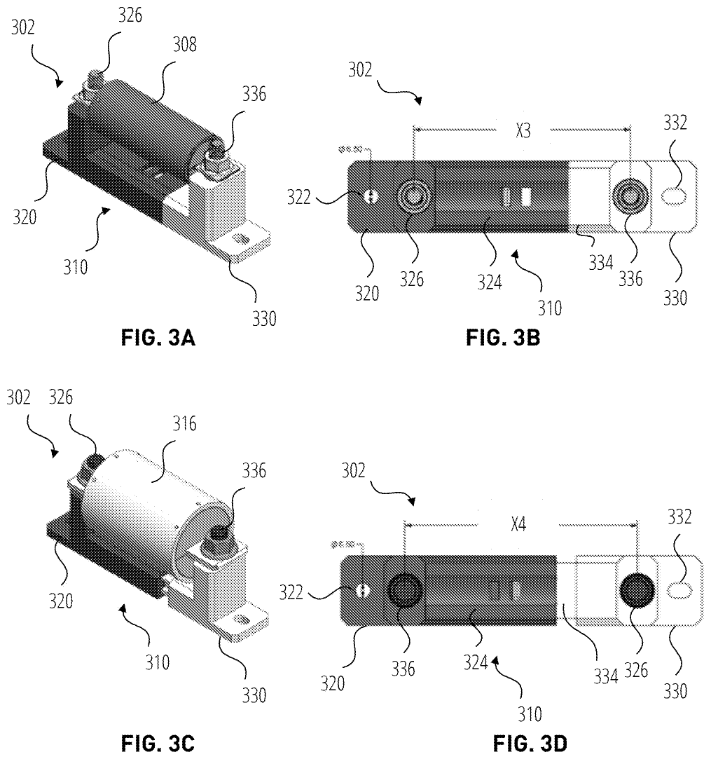

FIG. 3A is a perspective view illustrating a fuse holder 302 and a fuse device 308 in a first configuration, for example, a primary latching position, in accordance with disclosed embodiments, and FIG. 3B is a top view of the fuse holder 302 in the first configuration, that is, the primary latching position. FIG. 3C is a perspective view illustrating the fuse holder 302 and the fuse device 308 in a second configuration, for example, a secondary latching position, in accordance with disclosed embodiments, and FIG. 3D is a top view of the fuse holder 302 in the second configuration, that is, the secondary latching position.

As seen, the fuse holder 302 can include a first holding part 320 and a second holding part 330. The first holding part 320 can include a first mounting apparatus 322 at a first end of the first holding part 320, a first joint interface 324 at a second end of the first holding part 320 opposite the first end of the first holding part 320, and a first conductive terminal 326 in between the first end of the first holding part 320 and the second end of the first holding part 320. Similarly, the second holding part 330 can include a second mounting apparatus 332 at a first end of the second holding part 330, a second joint interface 334 at a second end of the second holding part 330 opposite the first end of the second holding part 330, and a second conductive terminal 336 in between the first end of the second holding part 330 and the second end of the second holding part 330.

The first joint interface 324 can lock with the second joint interface 334 in the primary latching position as illustrated in FIG. 3A and FIG. 3B or in the secondary latching position as illustrated in FIG. 3C and FIG. 3D to create and form a joint device 310. That is, the joint device 310 can be formed by the first joint interface 324 and the second joint interface 334 when latched together. When the joint device 310 is formed in the primary latching position, that is, the first joint interface 324 locks with the second joint interface 334 in the primary latching position, the first conductive terminal 326 can be a first distance X3 from the second conductive terminal 336. However, when the joint device 310 is formed in the secondary latching position, that is, the first joint interface 324 locks with the second joint interface 334 in the secondary latching position, the first conductive terminal 326 can be a second distance X4 from the second conductive terminal 336. As seen in FIG. 3B and FIG. 3C, the second distance X4 can be greater than the first distance X3.

Distances X3 and X4 can be different dimensions than distances X1 and X2. As such, fuse holders as disclosed and described herein are not limited to specific dimensions. Rather, a fuse holder can be designed with a first configuration to fit any first fuse device with first specifications and with a second configuration to fit any second fuse device with second specifications.

To move between the primary latching position and the secondary latching position, the joint device 310 can slide along an X axis between the primary latching position and the secondary latching position. For example, the second holding part 330 can slide relative to the first holding part 320, including toward or away from and/or into or out of, to move between the primary latching position and the secondary latching position. In some embodiments, the second joint interface 334 can be unlocked from the first joint interface 324 to move the second joint interface 334 between the primary latching position and the secondary latching position.

The same one single fuse holder 302 is illustrated in FIGS. 3A-3D, albeit in different configurations. As such, the fuse holder 302 can hold a first fuse device 308 with a first length and pitch in the first configuration, that is, the primary latching position, but can also hold a second fuse device 316 with a second length and pitch in the second configuration, that is, the secondary latching position. The second length can be longer than the first length, but a different fuse holder is not required. In particular, the first conductive terminal 326 and the second conductive terminal 336 can accommodate the first fuse device 308, for example, by connecting thereto, when the first joint interface 324 locks with the second joint interface 334 in the primary latching position. However, the first conductive terminal 326 and the second conductive terminal 336 can accommodate the second fuse device 316, for example, by connecting thereto, when the first joint interface 324 locks with the second joint interface 334 in the secondary latching position.

Once configured in the primary latching position or the secondary latching position, the fuse holder 302 can be mounted to any desired device as would be known and desired by one of skilled in the art. For example, in some embodiments, the first mounting apparatus 322 and the second mounting apparatus 332 can be secured to a panel or other device via mounting hardware. In some embodiments, the first mounting apparatus 322 and/or the second mounting apparatus 332 can include an M6 hole or slot for receiving an M6 stud and/or nut.

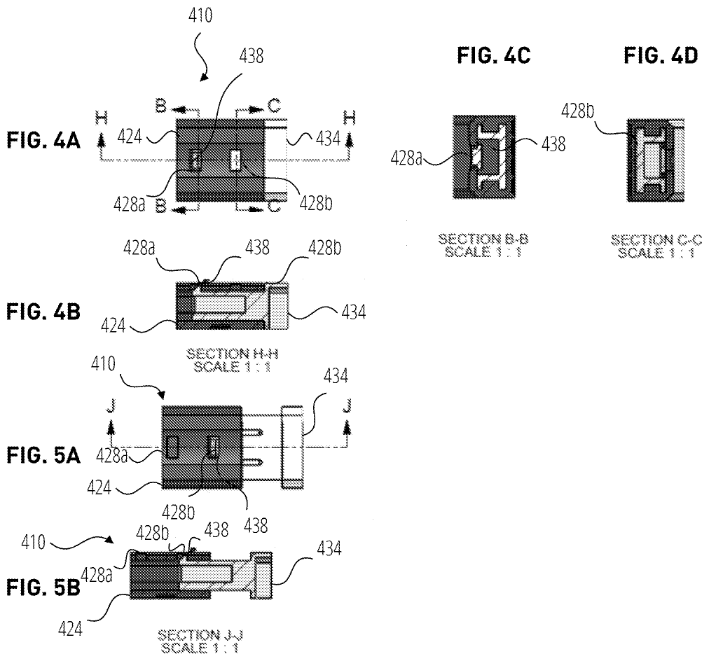

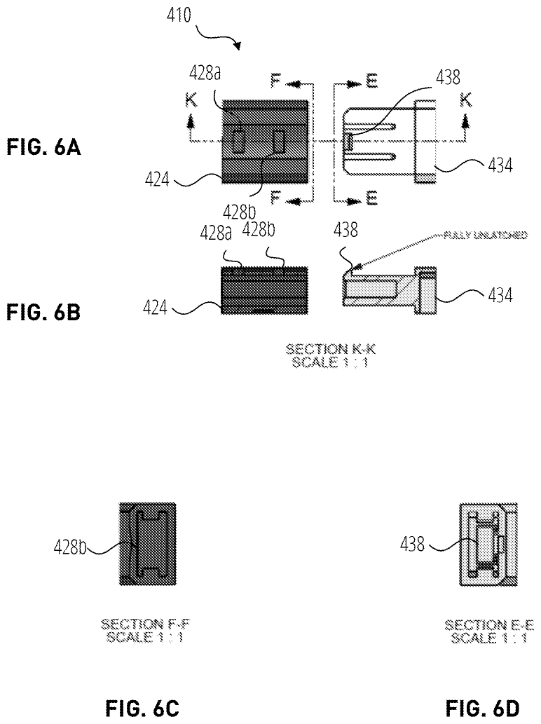

One embodiment of a sliding joint that includes a joint device in accordance with disclosed embodiments will now be described in more detail. FIG. 4A is a top view illustrating a joint device 410 in a primary latching position, FIG. 5A is a top view illustrating the joint device 410 in a secondary latching position, and FIG. 6A is a top view illustrating the joint device 410 in an unlatched position. It is to be understood that the joint device 410 can be the same as or similar to the joint device 210 and the joint device 310.

In some embodiments, the joint device 410 can be I-shaped. In particular, a first joint interface 424 of the joint device 410 can include a first receptacle 428a and a second receptacle 428b, and the second joint interface 434 of the joint device 410 can include a protruding tab 438.

As seen in FIG. 4A, in the primary latching position, the protruding tab 438 can lock and/or latch into, onto, and/or through the first receptable 428a. As such, the second receptacle 428b can remain empty.

FIG. 4B is a cross-sectional view of the joint device 410 of FIG. 4A along line H-H and illustrates the protruding tab 438 latched in the first receptacle 428a and the second receptacle 428b being empty in the primary latching position.

FIG. 4C is a cross-sectional view of the joint device 410 of FIG. 4A along line B-B and illustrates the protruding tab 438 latched in the first receptacle 428a in the latching position.

FIG. 4D is a cross-sectional view of the joint device 410 of FIG. 4A along line C-C and illustrates the second receptacle 428b being empty in the latching position.

However, as seen in FIG. 5A, in the secondary latching position, the protruding tab 438 can lock and/or latch into, onto, and/or through the second receptacle 428b. As such, the first receptacle 428a can remain empty.

FIG. 5B is a cross-sectional view of the joint device 410 of FIG. 5A along line J-J and illustrates the protruding tab 438 latched in the second receptacle 428b and the first receptacle 428a being empty in the secondary latching position.

To move between the primary latching position and the secondary latching position, the second joint interface 434 can slide toward or away from and/or into or out of the first joint interface 424, for example, along an X axis. In some embodiments, at least a portion of the second joint interface 434, including the protruding tab 438, can fit inside of the first joint interface 424 and slide within the first joint interface 424 to move between aligning the protruding tab 438 with the first receptacle 428a and the second receptacle 428b.

In some embodiments, the joint device 410 can be in the unlatched position to slide portions thereof, including the first joint interface 424 and/or the second joint interface 434. For example, as seen in FIG. 6A, in the unlatched position, the first receptacle 428a and the second receptacle 428b can remain empty. That is, in the unlatched position, the protruding tab 438 need not be latched in the first receptacle 428a or the second receptacle 428b.

FIG. 6A illustrates the second joint interface 434 as being completely outside of the first joint interface. However, it is to be understood that embodiments disclosed herein are not so limited and that the some or all of the second joint interface 434 can be inside of the first joint interface 424 in the unlatched position so long as the protruding tab 438 is outside of and/or unlatched from both the first receptacle 428a and the second receptacle 428b. That is, the unlatched position encompasses a plurality of different configurations of the first joint interface 424 and the second joint interface 434.

FIG. 6B is a cross-sectional view of the joint device 410 of FIG. 6A along line K-K and illustrates both the first receptacle 428a and the second receptacle 428b being empty and the protruding tab 438 being unlatched therefrom.

FIG. 6C is a cross-sectional view of the joint device 410 of FIG. 6A along line F-F and illustrates the second receptacle 428b being empty.

FIG. 6D is a cross-sectional view of the joint device 410 of FIG. 6A along line E-E and illustrates the protruding tab 438 being unlatched from both the first receptacle 428a and the second receptacle 428b.

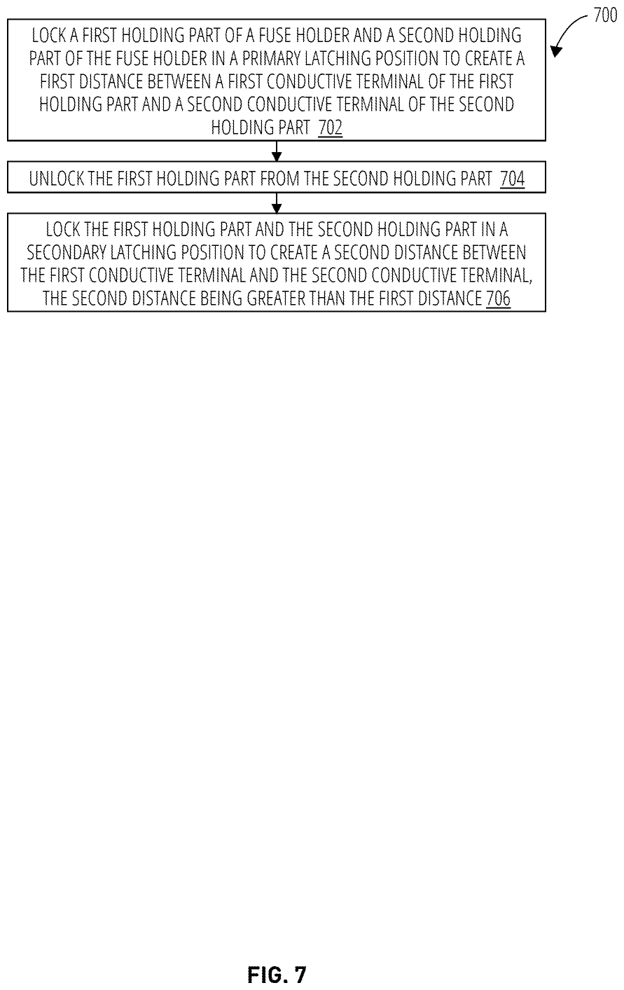

FIG. 7 is a flow chart illustrating a method 700 in accordance with disclosed embodiments. As seen, the method 700 can include locking a first holding part of a fuse holder and a second holding part of the fuse holder in a primary latching position to create a first distance between a first conductive terminal of the first holding part and a second conductive terminal of the second holding part as in 702. For example, a first joint interface of the first holding part can be locked with a second joint interface of the second holding part to create a joint device in the primary latching position. In some embodiments, the method 700 can also include mounting a first fuse device with a first length to the first conductive terminal and the second conductive terminal when the first holding part and the second holding part are locked in the primary latching position.

Then, the method 700 can include unlocking the first holding part from the second holding part as in 704. In some embodiments, after unlocking the second holding part from the first holding part, the method 700 can also include sliding the joint device along an X axis of the fuse holder between the primary latching position and the secondary latching position. For example, the method 700 can include sliding the second holding part relative to the first holding part to move between the first latching position and the secondary latching position.

Finally, the method 700 can include locking the first holding part and the second holding part in a secondary latching position to create a second distance between the first conductive terminal and the second conductive terminal as in 706. For example, the first joint interface of the first holding part can be locked with the second joint interface of the second holding part to create the joint device in the secondary latching position. In some embodiments, the method 700 can also include mounting a second fuse device with a second length to the first conductive terminal and the second conductive terminal when the first holding part and the second holding part are locked in the secondary latching position.

In some embodiments the second distance between the first conductive terminal and the second conductive terminal can be greater than the first distance between the first conductive terminal and the second conductive terminal. As such, in these embodiments, the second length of the second fuse device can be longer than the first length of the first fuse device.

As used herein, an element or a step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations, and changes to the described embodiments are possible without departing from the sphere and scope of the present disclosure, as defined in the appended claims. Accordingly, it is intended that the present disclosure not be limited to the described embodiments, but that it has the full scope defined by the language of the following claims and equivalents thereof.

What is claimed is:

1. A fuse holder comprising:
a first holding part, the first holding part including a first mounting apparatus at a first end of the first holding part, a first joint interface at a second end of the first holding part opposite the first end of the first holding part, and a first conductive terminal in between the first end of the first holding part and the second end of the first holding part;
a second holding part, the second holding part including a second mounting apparatus at a first end of the second holding part, a second joint interface at a second end of the second holding part opposite the first end of the second holding part, and a second conductive terminal in between the first end of the second holding part and the second end of the second holding part,
wherein the first joint interface locks with the second joint interface in a primary latching position or a secondary latching position,
wherein when the first joint interface locks with the second joint interface in the primary latching position, the first conductive terminal is a first distance from the second conductive terminal, and
wherein when the first joint interface locks with the second joint interface in the secondary latching position, the first conductive terminal is a second distance from the second conductive terminal, the second distance being greater than the first distance.

2. The fuse holder of claim 1 wherein the second holding part slides relative to the first holding part to move the second joint interface between the primary latching position and the secondary latching position.

3. The fuse holder of claim 2 wherein the second joint interface is unlocked from the first joint interface to move the second joint interface between the primary latching position and the secondary latching position.

4. The fuse holder of claim 1 wherein the first joint interface locks with the second joint interface to create a joint device.

5. The fuse holder of claim 4 wherein the joint device is I-shaped.

6. The fuse holder of claim 4 wherein the joint device slides along an X axis between the primary latching position and the secondary latching position.

7. The fuse holder of claim 1 wherein the first conductive terminal and the second conductive terminal accommodate a first fuse device with a first length when the first joint interface locks with the second joint interface in the primary latching position, wherein the first conductive terminal and the second conductive terminal accommodate a second fuse device with a second length when the first joint interface locks with the second joint interface in the secondary latching position, and wherein the second length is longer than the first length.

8. A fuse holder comprising:
a first holding part, the first holding part including a first joint interface and a first conductive terminal;
a second holding part, the second holding part including a second joint interface and a second conductive terminal,
wherein the first joint interface locks with the second joint interface in a primary latching position or a secondary latching position,
wherein when the first joint interface locks with the second joint interface in the primary latching position, the first conductive terminal is a first distance from the second conductive terminal, and
wherein when the first joint interface locks with the second joint interface in the secondary latching position, the first conductive terminal is a second distance from the second conductive terminal, the second distance being greater than the first distance.

9. The fuse holder of claim 8 wherein the second holding part slides relative to the first holding part to move the second joint interface between the primary latching position and the secondary latching position.

10. The fuse holder of claim 9 wherein the second joint interface is unlocked from the first joint interface to move the second joint interface between the primary latching position and the secondary latching position.

11. The fuse holder of claim 8 wherein the first joint interface locks with the second joint interface to create a joint device.

12. The fuse holder of claim 11 wherein the joint device is I-shaped.

13. The fuse holder of claim 11 wherein the joint device slides along an X axis between the primary latching position and the secondary latching position.

14. The fuse holder of claim 8 wherein the first conductive terminal and the second conductive terminal accommodate a first fuse device with a first length when the first joint interface locks with the second joint interface in the primary latching position, wherein the first conductive terminal and the second conductive terminal accommodate a second fuse device with a second length when the first joint interface locks with the second joint interface in the secondary latching position, and wherein the second length is longer than the first length.

15. A method comprising:
locking a first holding part of a fuse holder and a second holding part of the fuse holder in a primary latching position to create a first distance between a first conductive terminal of the first holding part and a second conductive terminal of the second holding part;
unlocking the first holding part from the second holding part; and
locking the first holding part and the second holding part in a secondary latching position to create a second distance between the first conductive terminal and the second conductive terminal, the second distance being greater than the first distance.

16. The method of claim 15 further comprising:
after unlocking the second holding part from the first holding part, sliding the second holding part relative to the first holding part to move between the first latching position and the secondary latching position.

17. The method of claim 15 further comprising:
mounting a first fuse device with a first length to the first conductive terminal and the second conductive terminal when the first holding part and the second holding part are locked in the primary latching position; and
mounting a second fuse device with a second length to the first conductive terminal and the second conductive terminal when the first holding part and the second holding part are locked in the secondary latching position,
wherein the second length is longer then the first length.

18. The method of claim 15 further comprising:
locking a first joint interface of the first holding part with a second joint interface of the second holding part to create a joint device in the primary latching position or the secondary latching position.

19. The method of claim 18 wherein the joint device is I-shaped.

20. The method of claim 18 further comprising:
sliding the joint device along an X axis of the fuse holder between the primary latching position and the secondary latching position.
